(19) United States
(12) Patent Application Publication
(10) Pub. No.: US 2022/0411639 A1
(43) Pub. Date: Dec. 29, 2022

(54) METHOD FOR SURFACE-TREATING INORGANIC PARTICLES, AND INORGANIC PARTICLES PRODUCED THEREBY

(71) Applicant: LG ELECTRONICS INC., Seoul (KR)

(72) Inventors: Chohee OH, Seoul (KR); Sanghyun HONG, Seoul (KR)

(21) Appl. No.: 17/793,250

(22) PCT Filed: Dec. 10, 2020
(86) PCT No.: PCT/KR2020/018095

§ 371 Date: Jul. 15, 2022

(30) Foreign Application Priority Data
Jan. 16, 2020 (KR) 10-2020-0006068

(51) Int. Cl. C09C 3/10; C09C 3/04; C09C 3/08

(52) U.S. Cl. CPC C09C 3/10; C09C 3/041; C09C 3/08

(57) ABSTRACT

The present invention relates to a method for surface-treating inorganic particles, and inorganic particles produced thereby. The method for surface-treating inorganic particles according to the present invention involves dry-milling inorganic particles and a coupling agent to pulverize the inorganic particles and couple the coupling agent to the surfaces of the inorganic particles, and thus may prevent problems that occur in conventional wet milling processes.

### FIELD

The present disclosure relates to a method for treating surfaces of inorganic particles applied as an additive of a polymer, and inorganic particles prepared by the method. The present disclosure relates to a method of treating surfaces of inorganic particles in one process by dry-milling the inorganic particles and a coupling agent, and inorganic particles prepared using the method.

### DESCRIPTION OF RELATED ART

In general, in order to prepare a polymer composite in which ceramic particles are uniformly dispersed, a process of treating surfaces of the particles with a surfactant having affinity with a polymer matrix or applying a chemical functional group to the surfaces of the particles is required.

However, this process consumes a lot of process time and goes through a complex chemical reaction process. That is, a conventional preparing process of a polymer composite in which particles are dispersed has a problem in that the process is complicated and economical efficiency is lost due to limitation of a production amount.

Therefore, there is a need for a method capable of preparing particles and performing surface treatment thereof at the same time, thereby shortening a process time and simplifying the process and improving economic feasibility of the polymer composite.

A related prior document includes Korean Patent No. 10-1239356 (published on Jun. 29, 2012) which discloses a method for preparing a ceramic nanopowder surface-treated with a hydrophobic polymer, and a ceramic nanopowder as prepared according to the method. However, in this prior document, this method uses a wet milling process such that the nanopowders tend to agglomerate with each other, and properties of the nanopowder are deteriorated due to a drying process and various chemical reactions caused by the wet milling process.

### DISCLOSURE

### Technical Purpose

Therefore, a purpose of the present disclosure is to provide a method for treating surfaces of inorganic particles in which all processes are carried out in a dry manner, so that no drying process may be required, and change in physical properties of the inorganic particles, and environmental pollution and toxicity caused by solvent due to chemical reaction caused by a wet process may not occur.

Further, another purpose of the present disclosure is to provide inorganic particles produced by dry-milling inorganic particles and a coupling agent and thus having reduced average particle sizes and improved impact strength.

Purposes of the present disclosure are not limited to the above-mentioned purpose. Other purposes and advantages of the present disclosure that are not mentioned may be understood based on following descriptions, and may be more clearly understood based on embodiments of the present disclosure. Further, it will be easily understood that the purposes and advantages of the present disclosure may be realized using means shown in the claims and combinations thereof.

### Technical Solution

In order to achieve the above-mentioned technical purposes, the present disclosure provides a method for treating surfaces of inorganic particles which binds the inorganic particles and the coupling agent to each other in the dry-milling process that does not use a solvent so that there is no problem which otherwise occurs in the wet milling process and the particles are uniformly dispersed in a polymer matrix, and durability of a product containing the same is improved.

Specifically, the present disclosure provides a method for treating surfaces of inorganic particles, the method comprising: dry-milling the inorganic particles and a coupling agent to pulverize the inorganic particles and to bind the coupling agent to the surfaces of the inorganic particles.

Further, the present disclosure provides inorganic particles produced by the method including dry-milling the inorganic particles and the coupling agent to pulverize the inorganic particles and to bind the coupling agent to the surfaces of the inorganic particles such that the inorganic particles as produced have a reduced average particle size and improved impact strength.

### Technical Effect

According to the present disclosure, the method for treating the surfaces of inorganic particles may be realized in which the pulverizing and the surface treatment of inorganic particles may be simultaneously performed using a simple dry-milling process, such that a need for the drying process performed in the wet milling is removed and a chemical reaction between the solvent used in the wet process and the inorganic particles does not occur.

Further, there is no agglomeration of particles or deterioration of particle properties due to residual solvent occurring in the wet milling. Further, there is no problem of environmental pollution and human toxicity caused by the solvent.

Further, when the inorganic particles obtained using the surface treatment method according to the present disclosure are applied as an additive to a polymer matrix, wettability and adhesion thereof are improved due to high bonding strength thereof to the polymer, so that the particles may be uniformly dispersed in the polymer matrix. Accordingly, when the polymer is applied to an injection molded product, impact strength and physical properties thereof may be improved. When the polymer is applied as a coating layer, durability of a product may be improved due to high bonding strength of the coating layer thereto.

Furthermore, each of the inorganic particles prepared using the preparation method according to an embodiment of the present disclosure may have a smaller particle size than a particle size of each of the original inorganic particles before the treatment because a surface energy due to the coupling agent is reduced in the pulverizing. This may lower a surface roughness when the polymer matrix is applied to the injection molded product or as the coating layer, thereby achieving a uniform surface.

### BRIEF DESCRIPTION OF DRAWINGS

FIG. 1 is a schematic diagram showing a method for treating surfaces of inorganic particles according to an embodiment of the present disclosure.

FIG. 2 is a schematic diagram showing a field to which inorganic particles surface-treated using a method for treating surfaces of inorganic particles according to an embodiment of the present disclosure are applied.

FIG. 3 is a graph showing an impact strength of inorganic particles according to an embodiment of the present disclosure.

### DETAILED DESCRIPTIONS

The purposes, features, and advantages as above-mentioned will be described later in detail, and accordingly, a person with ordinary knowledge in the technical field to which the present disclosure belongs will be able to easily implement the technical idea of the present disclosure. In describing the present disclosure, specific descriptions of known components and steps related to the present disclosure may unnecessarily obscure the gist of the present disclosure. In this case, the specific descriptions thereof are omitted. Hereinafter, a preferred embodiment according to the present disclosure will be described in detail.

The present disclosure is not limited to embodiments as disclosed below, but may be implemented in various different forms. Thus, these embodiments are set forth only to make the present disclosure complete, and to completely inform the scope of the present disclosure to those of ordinary skill in the technical field to which the present disclosure belongs.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

As used herein, a term “A and/or B” includes A, B, and a combination of A and B unless otherwise specified. When referring to “C to D”, this means C inclusive to D inclusive unless otherwise specified.

Hereinafter, a method for treating surfaces of inorganic particles according to the present disclosure and thus surface-treated inorganic particles will be described in detail.

The present disclosure provides a method for treating surfaces of inorganic particles, the method including dry-milling the inorganic particles and a coupling agent to pulverize the inorganic particles and bond the coupling agent to the surfaces of the inorganic particles.

Conventionally, in order to apply inorganic particles as an additive to a polymer matrix, a process of treating the surfaces of the inorganic particles with a surfactant having affinity with the polymer matrix or applying a chemical functional group to the surfaces of the particles is performed.

However, this process takes a lot of time and must undergo a complex chemical reaction. As a result, a production amount is reduced and thus economical efficiency is not achieved.

Further, in the prior art, a milling process is carried out in a wet manner, so that an additional drying process is required. In this regard, in a process of drying a solvent, pulverized powders of the inorganic particles are strongly agglomerated with each other. Therefore, when the inorganic particles are used as the additive in a powder state, a separate deagglomeration process is required.

Further, when using the wet process, a process of selecting a solvent that does not react with the particles to be surface-treated and a process of verifying the selection are required.

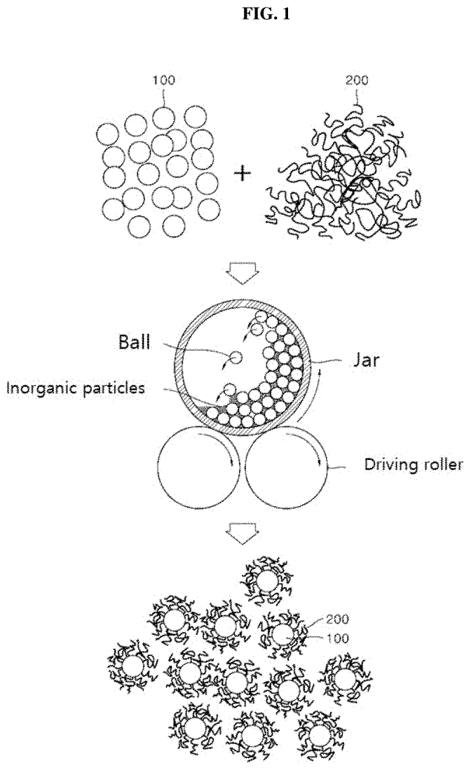

FIG. 1 is a schematic diagram showing a method for treating surfaces of inorganic particles according to an embodiment of the present disclosure. The method for treating the surfaces of the inorganic particles according to an embodiment of the present disclosure employs only dry-milling such that a drying process added when using the wet milling is not required, and a chemical reaction to be considered in the wet milling does not occur.

Further, the method employs only the dry-milling such that agglomeration of the particles and degradation of particle properties due to residual solvent occurring in the wet milling may not occur, and environmental pollution and human harm caused by the solvent used in the wet milling may be prevented.

In the method for treating the surfaces of the inorganic particles according to an embodiment of the present disclosure, a coupling agent 200 may be at least one selected from a group consisting of octadecyltrimethoxysilane (OTMS), octadecylethoxysilane (OTES), glycidyloxypropyltrimethoxy silane (GPTMS) and methacryloxypropyltrimethoxysilane (MPTMS).

The coupling agent 200 is preferably added in an amount of 0.001 to 0.1 wt % based on a total weight of the inorganic particles 100 and the coupling agent 200. When the coupling agent 200 is added in an amount of smaller than 0.001% by weight, the surface treating of the inorganic particles 100 is not sufficiently performed, so that the particles are not bound to the polymer matrix. When the coupling agent 200 is added in an amount of larger than 0.01% by weight, the coupling agents 200 are agglomerated with each other on the surfaces of the inorganic particles 100 such that a bonding strength of the particles with the polymer matrix is lowered.

In the method for treating the surfaces of the inorganic particles according to an embodiment of the present disclosure, the dry-milling may be performed to pulverize the inorganic particles 100 and achieve a surface treatment thereof.

Specifically, the dry-milling may allow the coupling agent 200 to be coated on the surfaces of the inorganic particles 100, so that the surface properties of the inorganic particles 100 may be changed or functional groups may be adsorbed thereto.

In other words, the method for treating the surfaces of inorganic particles according to an embodiment of the present disclosure performs the dry-milling. Thus, intrinsic properties of inorganic particles 100 and properties thereof such as flowability, wettability, and dispersibility are improved. Further, in a one-step process, pulverizing and surface treatment of the inorganic particles 100 may be performed simultaneously.

The dry-milling may be selected from a group consisting of ball milling, attrition milling, vibration milling, and hammer milling. When the dry-milling is the ball milling, the ball milling is preferably carried out using a ball of 5 to 10 mm, and within 3 hours and at 400 to 700 rpm.

When the dry-milling is performed at a rpm outside the above-mentioned rpm range and is performed for more than 3 hours, heat is generated due to friction between the balls and the inorganic particles during the milling process, which may deteriorate the physical properties of the inorganic particles 100 and the coupling agent 200.

Further, in order to prevent the above-mentioned problem, the method may perform dry-milling on the inorganic particles 100 so as to have a particle size close to a final target particle size, and may add the coupling agent 200 thereto and then may perform dry-milling on the particles and the coupling agent.

In the method for treating the surfaces of the inorganic particles according to an embodiment of the present disclosure, an alcohol-based solvent may be further used when the surfaces of the particles are treated.

This is to improve the surface treatment efficiency during surface treatment of the inorganic particles 100. The alcohol-based solvent may include ethanol or isopropyl alcohol (IPA).

In this regard, the alcohol-based solvent does not affect the inorganic particles because the alcohol is automatically vaporized due to the heat generated during the milling process.

Further, the present disclosure provides inorganic particles as surface-treated using the method for treating the surfaces of the inorganic particles as above-described, wherein the surface-treated inorganic particles include the inorganic particles; and the coupling agent coupled to the surfaces of the inorganic particles.

Further, when the inorganic particles surface-treated using the surface treatment method according to an embodiment of the present disclosure are applied as an additive to a polymer, wettability and adhesion are improved due to high bonding force thereof with the polymer, so that the inorganic particles may be uniformly dispersed in the polymer matrix. Accordingly, when the polymer matrix is applied to an injection molded product, impact strength and physical properties thereof may be improved. When the polymer matrix is applied as a coating layer, durability of a product may be improved due to the high bonding strength of the coating layer thereto.

Further, each of the inorganic particles prepared using the preparation method according to an embodiment of the present disclosure may have a smaller particle size than a particle size of each of the original inorganic particles before the treatment because a surface energy due to the coupling agent is reduced in the pulverizing. This may lower a surface roughness when the polymer matrix is applied to the injection molded product or as the coating layer, thereby achieving a uniform surface.

The coupling agent may include a silane coupling agent as described above. Specifically, the coupling agent may be at least one selected from a group consisting of octadecyltrimethoxysilane (OTMS), octadecylethoxysilane (OTES), glycidyloxypropyltrimethoxy silane (GPTMS) and methacryloxypropyltrimethoxysilane (MPTMS).

Each of the inorganic particles surface-treated using the surface treatment method according to an embodiment of the present disclosure has an average particle size reduced by 60 to 80%, compared to that of each of starting inorganic particles. The inorganic particles surface-treated using the surface treatment method has an impact strength improved by 29% or larger, compared to that of the starting inorganic particles.

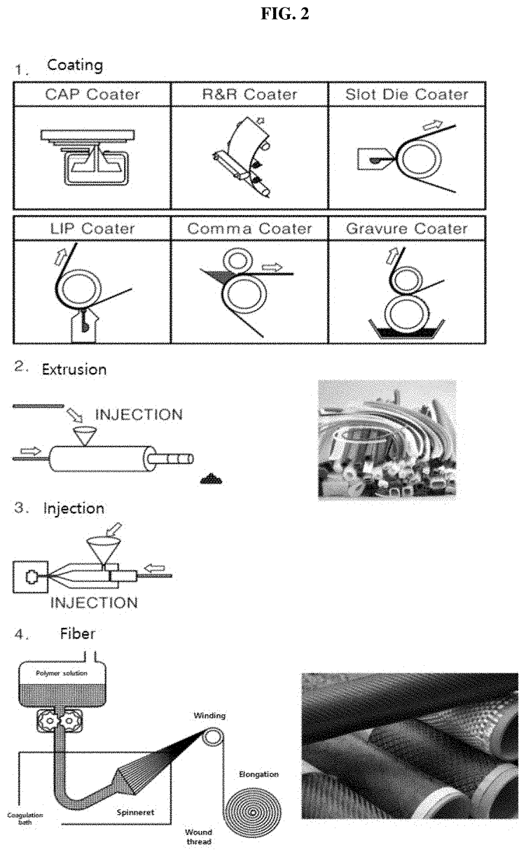

FIG. 2 is a schematic diagram showing a field to which surface-treated inorganic particles obtained using the method for treating the surfaces of the inorganic particles according to an embodiment of the present disclosure are applied. The surface-treated inorganic particles obtained using the method for treating the surfaces of the inorganic particles according to an embodiment of the present disclosure may be applied to a coating solution, an extruded product, an injection molded product, fibers, etc. in which the inorganic particles may be added as an additive (heat dissipation material, antibacterial material, impact absorbing material) into the polymer matrix, or may be applied to inorganic materials such as glass and ceramics, and metal materials.

### Present Example 1: Preparing of Surface-Treated Inorganic Particles (1)

Glass powders were used as inorganic particles, and glycidyloxypropyltrimethoxysilane (GPTMS) was used as a coupling agent. The glass powders were put into a ball milling apparatus and were dry-milled to pulverize the glass powders, and then glycidyloxypropyltrimethoxysilane (GPTMS) was added thereto and then dry-milling was performed. At this time, the coupling agent was added in an amount of 0.001% by weight of a total weight of the glass powders and the coupling agent, and the dry-milling was performed at 500 rpm for 2 hours and 30 minutes using a 10 mm ball.

### Present Example 2: Preparing of Surface-Treated Inorganic Particles (2)

Surface-treated inorganic particles were prepared in the same manner as in the Present Example 1, except that the coupling agent was added in an amount of 0.05 wt % by weight of the total weight of the glass powders and the coupling agent.

### Present Example 3: Preparing of Surface-Treated Inorganic Particles (3)

Surface-treated inorganic particles were prepared in the same manner as in the Present Example 1, except that the coupling agent was added in an amount of 0.01 wt % by weight of the total weight of the glass powders and the coupling agent.

### Present Example 4: Preparing of Surface-Treated Inorganic Particles (4)

Surface-treated inorganic particles were prepared in the same manner as in the Present Example 1, except that the coupling agent was added in an amount of 0.05 wt % by weight of the total weight of the glass powders and the coupling agent and ethanol was added.

### Present Example 5: Polymer Matrix to which Surface-Treated Inorganic Particles are Added

The surface-treated inorganic particles prepared in the Present Example 2 were added to acrylonitrile butadiene styrene (ABS) polymer matrix.

### Comparative Example 1

Glass powders were pulverized in a dry-milling manner under the same conditions as those in the Present Example 1, except that no coupling agent was added to the glass powders.

### Experimental Example 1: Analysis of Particle Size of Surface-Treated Inorganic Particle

We measured an average particle size of each of surface-treated inorganic particles obtained using the surface treatment method according to an embodiment of the present disclosure, and an average particle size of each of the glass powders subjected to the dry-milling without adding the coupling agent thereto. Results are shown in Table 1.

TABLE 1

| Examples | Average particle size |
|---|---|
| Comparative Example 1 | 12 μm |
| Present Example 3 | 8.5 μm |

As shown in the Table 1, the average particle size of the glass powders subjected to the dry-milling without adding the coupling agent thereto was 12 μm. The average particle size of each of surface-treated inorganic particles obtained using the surface treatment method according to an embodiment of the present disclosure was 8.5 μm.

As may be identified from Table 1, when the coupling agent is added in the dry-milling, the average particle size of the glass powders becomes smaller. Thus, when the polymer matrix containing the surface-treated inorganic particles is applied as a coating layer or to an injection molded product, the surface roughness is lowered to implement a uniform surface, such that the coating layer or the injection molded product is aesthetically advantageous.

### Experimental Example 2: Analysis of Impact Strength of Surface-Treated Inorganic Particles

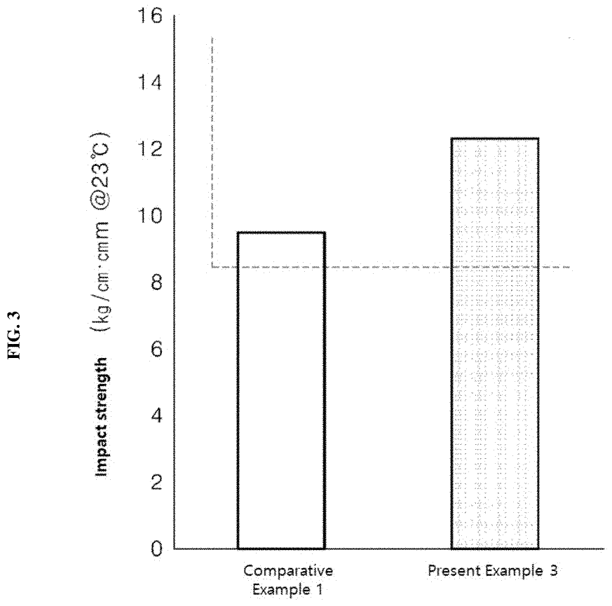

We measured impact strength of surface-treated inorganic particles obtained using the surface treatment method according to an embodiment of the present disclosure, and impact strength of the glass powders subjected to the dry-milling without adding the coupling agent thereto. A result is shown in FIG. 3.

As shown in FIG. 3, the impact strength of the glass powders (Comparative Example 1) subjected to the dry-milling without adding the coupling agent thereto was 9.7 kg/cm·cm. The impact strength of surface-treated inorganic particles (Present Example 3) obtained using the surface treatment method according to an embodiment of the present disclosure was 12.2 kg/cm·cm.

Therefore, it may be identified that the impact strength of the glass powders is improved when the coupling agent is added thereto in the dry-milling process.

As may be identified in Experimental Example 1, each of the inorganic particles surface-treated using the surface treatment method according to an embodiment of the present disclosure has an average particle size reduced by 60 to 80%, compared to that of each of the inorganic particles subjected to the dry-milling without adding the coupling agent thereto. Further, as may be identified in Experimental Example 2, the inorganic particles surface-treated using the surface treatment method according to an embodiment of the present disclosure has an impact strength improved by 29% or larger, compared to that of the starting inorganic particles subjected to the dry-milling without adding the coupling agent thereto.

The present disclosure has been described above with reference to the illustrated drawings. However, the present disclosure is not limited to the embodiments disclosed in the present specification, and the drawings. It is evident that various modifications may be made by those skilled in the art within the scope of the technical idea of the present disclosure. In addition, when an effect according to a configuration of the present disclosure is not explicitly described while describing the embodiments of the present disclosure above, it is natural that a predictable effect from the configuration should also be recognized.

1. A method for treating surfaces of inorganic particles, the method comprising:
dry-milling the inorganic particles and a coupling agent to pulverize the inorganic particles and to bind the coupling agent to the surfaces of the inorganic particles.

2. The method of claim 1, wherein the coupling agent includes at least one material selected from a group consisting of octadecyltrimethoxysilane (OTMS), octadecylethoxysilane (OTES), glycidyloxypropyltrimethoxy silane (GPTMS) and methacryloxypropyltrimethoxysilane (MPTMS).

3. The method of claim 1, wherein the coupling agent is added in an amount of 0.001 to 0.1% by weight of a total weight of the inorganic particles and the coupling agent.

4. The method of claim 1, wherein the dry-milling includes a milling that is selected from a group consisting of ball milling, attrition milling, vibration milling, and hammer milling.

5. The method of claim 1, wherein the dry-milling is performed within 3 hours at 400 to 700 rpm and using a ball of 5 to 10 mm.

6. The method of claim 1, wherein in binding the coupling agent to the surfaces of the inorganic particles, an alcohol-based solvent is further used.

7. The method of claim 6, wherein the alcohol-based solvent includes at least one of ethanol or isopropyl alcohol (IPA).

8. The method of claim 1, wherein the coupling agent is added after pulverizing the inorganic particles.

9. Inorganic particles prepared using the method of claim 1, wherein the prepared inorganic particles comprise:
the inorganic particles; and
the coupling agent coupled to the surfaces of the inorganic particles.

10. The inorganic particles of claim 9, wherein the coupling agent includes at least one selected from a group consisting of octadecyltrimethoxysilane (OTMS), octadecylethoxysilane (OTES), glycidyloxypropyltrimethoxy silane (GPTMS) and methacryloxypropyltrimethoxysilane (MPTMS).

11. The inorganic particles of claim 9, wherein the coupling agent is added in an amount of 0.001 to 0.1% by weight of a total weight of the inorganic particles and the coupling agent.

12. The inorganic particles of claim 9, wherein the prepared inorganic particles have an average particle size smaller by 60 to 80% compared to an average particle size of the inorganic particles before the dry milling, and
wherein the prepared inorganic particles have an impact strength of 29% or larger compared to an impact strength of the inorganic particles before the dry milling.
